(19) United States
(12) Patent Application Publication
(10) Pub. No.: US 2003/0154215 A1
(43) Pub. Date: Aug. 14, 2003

(54) Subscriber equipment for broadcast information and method therefor

(76) Inventor: Anson Chi Kit Cheung, Reuters (HK)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/074,621

(22) Filed: Feb. 13, 2002

(51) Int. Cl. G06F 7/00

(52) U.S. Cl. 707/104.1

(57) ABSTRACT

Subscriber equipment (300) is provided with a data storage device (350), such as a hard disk drive. A data processor (325) receives update messages. When the data processor (325) determines that the information code of an update message is on the subscriber's watch list, the data processor (325) processes the update and provides the processed update for display or further processing. When the information code is that of a selected record i.e. one that the subscriber is interested in, the data processor (325) processes the update and stores the processed update in a cache (330). However, when the information code is not of interest to the subscriber i.e. not on the subscriber's watch list and not that of a selected record, then the data processor does not process the record. Instead, the data processor (325) indexes and stores the unprocessed record in the data storage module (350).

### FIELD OF THE INVENTION

The present invention relates to subscriber equipment, and more particularly to subscriber equipment that receives and provides broadcast information that is frequently updated.

### BACKGROUND OF THE INVENTION

Information service companies, also referred to as information service providers, provide information including financial data and news on a subscription basis to subscribers. The subscribers are predominantly commercial entities, and the information provided includes records such as company annual reports; company results announcements; company share prices; news items relating to particular companies; news items and market prices relating to market sectors (e.g. telecommunications, banking, or pharmaceuticals); commodity prices, and so on. Each record provides information on a specific subject and each record has a number of information fields. For example, a record that provides the stock information of a particular company can include information fields that provide the last transacted price on a particular day, the change in stock price relative to the previous day, the day's highest price, the day's lowest price, the opening price, the current bid and ask prices, the volume of stock traded, and a variety of other information.

In order to update the information and keep the record current, an information service provider continuously broadcasts a large number of update messages that provide the updates to the records, ideally updates are provided as and when events occur. Returning to the example of stock information, while some of the fields of a record do not change through the course of a day, such as the opening price on a particular day, other fields, such as the current bid and ask prices and the volume of stock traded, tend to change rather frequently. Consequently, throughout the day update messages are transmitted to provide updates to the fields of a record that change.

When a subscriber subscribes to a particular service subscription package provided by an information service provider, subscriber equipment usually located at the subscriber's premises, receives and processes all update messages that provide updates to records associated with the particular service subscription package. However, a subscriber typically monitors only a portion of the records delivered under a service subscription package. The portion of records can be referred to as a subscriber's watch list.

In a conventional method for receiving and processing information, each record has a pre-assigned information code, and update messages are transmitted comprising an update for a particular record and includes the corresponding information code of that particular record.

With reference to FIG. 1, conventional subscriber equipment 100 for receiving and processing update messages comprises a satellite receiver 105 and a computer 110, which for simplicity of description, includes a subscriber input 112, such as a keyboard and mouse, and a display 114. The computer 110, which comprises a microprocessor based system operating in accordance with a software program, as is known in art, provides a variety of functional blocks or modules. These include a filter 115, a data processor 125, a cache 130, a record request module 135, and a display/subscriber application module 140.

The filter 115 functions like a cable TV box that receives update messages and passes only the update messages that correspond to records in a subscriber's service subscription package. The filter 115 accomplishes this by checking the information code of the update message, and determining that the information code complies with the information codes of records provided with the service subscription package. The filter 115 filters the received update message and provides filtered data, which the data processor 125 then processes to recover the transmitted update. When the information code of the update message is not on the subscriber's watch list, the data processor 125 processes and applies the update to the respective record stored in the cache 130. On the other hand, when the information code is on the subscriber's watch list, the data processor 125 processes and provides the update directly to the display/user application module 140. In addition, the data processor 125 also provides the update to the cache 130 to update records in the cache 130. In this way, messages that provide updates to records on the subscriber's watch list are processed and made available to the subscriber immediately, while records that are not on the subscriber's watch list are processed and only applied to the records in the cache 130, thus maintaining updated records in the cache 130.

When a subscriber wants to add a record to the watch list, the subscriber provides a subscriber request comprising the information code of the record to the subscriber input 112. The subscriber request module 135 receives the requested information code via the display/subscriber application module 140, gets the requested record from the cache 130, and provides the requested record to the display/subscriber application module 140. Upon receiving the retrieved record, the display/subscriber application module 140 presents the retrieved record on the display 114 or further processes the retrieved record as determined by the display/subscriber application module 140.

The display/subscriber application module 140 works with the subscriber input 112 and the display 114 to provide an interface between a subscriber or subscriber equipment and the computer 110. In some circumstances the display/subscriber application 140 module comprises equipment provided by the information service provider. Often, however, the display/subscriber application module 140 comprises proprietary subscriber equipment and software that communicates with the computer 110 and processes records provided by the information service provider in accordance with the particular requirements of the subscriber.

For reliable information delivery, a system for broadcasting update messages typically supports recovery from intermittent transmission errors or complete failures in the transmission path between the information service provider and the subscriber equipment. In addition, the system should also support new or repaired subscriber equipment that are beginning reception. Consequently, for each record there are three types of update messages that are broadcasted from the information service provider. A first type of message is an update message that provides updates for individual fields of the record. For example, the last traded price of an equity. A second type of message is an intermediate consolidated update message that provides updates for all the fields of the record that changed over a predetermined short cycle period i.e. an aggregation of the changes in a short cycle period of fifteen minutes. For example, fields providing the latest values for the last traded bid and offer prices of an equity. The intermediate consolidated update message allows recovery from intermittent transmission errors. A third type of message is a complete consolidated update message that provides updates for all the fields of a record. A complete consolidated update message provides the most up-to-date snapshot of a record i.e. a complete record image, and is transmitted once over a predetermined long cycle period of four hours. The complete consolidated update message allows the subscriber equipment to recover from long outages.

The filter 115 receives and passes all three types of messages associated with a service subscription package to the data processor 125. The data processor 125 processes each update message and applies and stores or presents/provides the updates as dictated by the watch list, as described earlier.

A disadvantage of this broadcast method is the need for powerful and expensive subscriber equipment, as the computer 110 has to process all update messages for all records that are received by the subscriber equipment in accordance with a service subscription package. For example, when two million records are supported, the update message traffic can amount to about ten thousand update messages per second or more. When the update message traffic increases, conventional subscriber equipment are unable to cope with the volume of update messages that need to be processed. Sometimes, a compromise has to be made to limit the number of records that can be provided to subscribers to reduce the update message traffic to a level that can be supported by more economical subscriber equipment.

To overcome this limitation, an additional communication link or back link has been incorporated between the information service provider and the subscriber equipment. With additional equipment the information service provider can receive and process a subscriber request for a particular record from the subscriber equipment via the back link, and provide the requested record initially via the back link, and then provide subsequent updates for the record via broadcast.

With reference to FIG. 2, a known system 200 that incorporates the additional communication back link includes a satellite receiver 105 and a computer 210 with the subscriber input 112 and the display 114. Similar to the one described earlier, the computer 210 includes a variety of functional blocks, including a filter 215, a data processor 225, a cache 230, a subscriber request module 235, and a display/subscriber application module 140. The filter 215 receives and passes only the update messages with information codes that correspond to a subscriber's service subscription package, which is accomplished as describe before. In addition, the filter 215 is coupled to receive information codes for subscriber requested records from the data processor 225 and transmit the request information code via a communication back link 227 to the information service provider (not shown). The data processor 225 is also coupled to cache 230 for storage of records.

A subscriber request module 235 receives subscriber requests from the subscriber input 112 via the display/subscriber application module 140, and is coupled to the cache 230 and the data processor 225. The subscriber request module 235 provides requested information codes to the data processor 225.

Initially, with no records stored in the cache 230, when a subscriber request for a particular record is received from the subscriber input 112, the subscriber request module 235 communicates the request via the back link 227 to the information service provider. In response, the filter 215 receives and passes an update message that provides the requested record. The received record is processed by the data processor 225 and provided to the display/subscriber application module 140. Subsequently, when update messages that provide updates to the record are received, the filter 215 passes the update messages, which are then processed to apply the update to the record.

In time, subscriber requests for a variety of records results in a watch list of the information codes of those records, and the subscriber's watch list is maintained by the data processor 225. When the filter 215 receives update messages for any of the records on the watch list, the update messages are processed and provided directly to the display/subscriber application module 140. Typically, a subscriber is interested in a larger number of records than the number of records on his watch list, and this can be a multiple of the number of records on the watch list. In order to mediate subscriber request traffic between the subscriber equipment and the information service provider, and provide timely response to a subscriber's request, the records that a subscriber is interested in are stored and maintained updated in the cache 230. The records that a subscriber is interested in and which are stored in the cache 230 will be referred to hereinafter as selected records. The method and criteria that are used to determine selected records may be varied and will not be described here.

Hence, update messages that provide updates for selected records will be processed and the update applied to the respective record stored in the cache, and update messages that provide updates for records that are on the subscriber's watch list are processed and provided directly to the display/subscriber application module 140. This includes updates provided by the intermediate consolidated update messages and the complete consolidated update messages

When the subscriber request module 235 receives a request for a record as a result of a subscriber request, the subscriber request module 235 first searches the cache 230 to determine whether the requested record is a selected record i.e. if the requested record is stored in the cache 230. When the requested record is not a selected record, only then is the subscriber request sent via the back link 227 to the information service provider. Of course when a requested record is available in the cache 230 it is retrieved and provided to the display/subscriber application module 140.

With the back link, the data processor 225 does not now need to process all update messages as the filter 215 only passes update messages that either provide updates for selected records or for records in the subscriber's watch list. Hence, with the lower volume of update message traffic, a lower powered computer and a cache with a smaller capacity may be employed in the subscriber equipment 200, as the number of update messages that are processed is now substantially less than that in the broadcast method.

A disadvantage of this method is the need for the additional communication link, which adds to the costs and complexity of the system. This is due to the need for suitable communication links and additional equipment for the information service provider to receive and process subscriber requests. Another disadvantage of this method is that suitable communication links may not be readily available in regions in which subscribers are located.

Hence, there is a need for subscriber equipment that receives information broadcast from an information service provider which does not require an additional communication link, and does not require a high powered processor.

### BRIEF SUMMARY OF THE INVENTION

The present invention seeks to provide subscriber equipment for broadcast information and a method therefor which overcomes, or substantially reduces, the abovementioned problems of the prior art.

Accordingly, in one aspect, the present invention provides an apparatus for continuously receiving update messages for a plurality of records, wherein each of the plurality of records has an identifier (ID), and wherein each update message comprises an update and one of the IDs, the apparatus comprising:

an input for receiving at least some of the update messages;

a processor coupled to the input, the processor for processing each update message when the ID of the update message is one of a first plurality of IDs, and for providing a processed update and the one of the first plurality of IDs to a first output, and the processor for providing the update message and the ID of the update message to a second output, without first processing the update message, when the ID of the received update message is not one of the first plurality of IDs; and

a first memory coupled to the second output for storing the update message and the ID of the update message.

In another aspect the present invention provides a method for processing update messages for a plurality of records, wherein each of the plurality of records has an identifier (ID), and wherein each update message comprises an update and one of the IDs, the method comprising the steps of:

receiving at least some of the update messages;

when the ID of a received update message is one of a first plurality of IDs, processing the update message to produce an update and providing the update and the ID of the received update message to a first output; and

when the ID of the received update message is not of the first plurality IDs, storing the update message and the ID of the received update message in a first memory, without first processing the update message.

### BRIEF DESCRIPTION OF THE DRAWINGS

An embodiment of the present invention will now be fully described, by way of example, with reference to the drawings of which:

FIG. 1 shows subscriber equipment in accordance with the prior art;

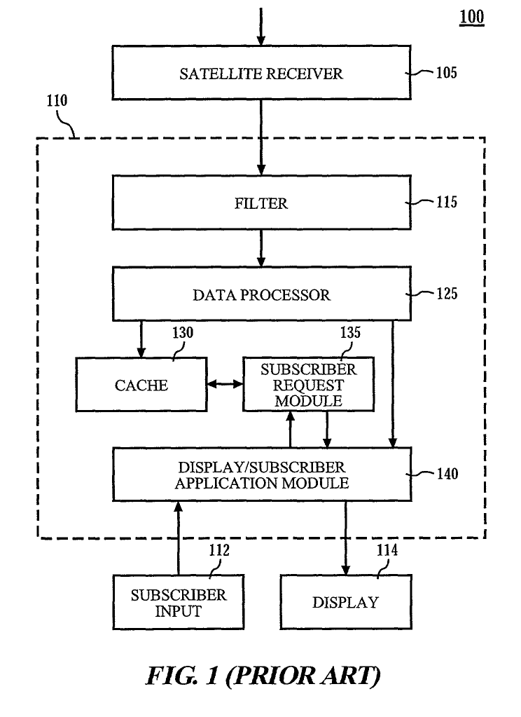

FIG. 2 shows alternate subscriber equipment in accordance with the prior art;

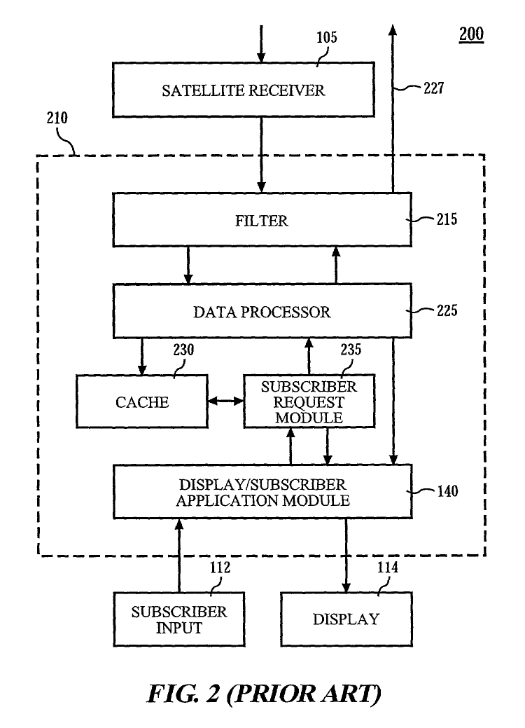

FIG. 3 shows subscriber equipment in accordance with the present invention;

FIG. 4 shows representations of update messages received by the subscriber equipment in FIG. 3;

FIG. 5 shows a representation of the messages in FIG. 4 stored in a memory of the subscriber equipment in FIG. 3;

FIG. 6 shows a flowchart detailing the operation of the subscriber equipment in FIG. 3 when an update message is received;

FIG. 7 shows a flowchart detailing the operation of the subscriber equipment in FIG. 3 when an intermediate consolidated update message is received;

FIG. 8 shows a flowchart detailing the operation of the subscriber equipment in FIG. 3 when a complete consolidated update message is received; and

FIG. 9 shows a flowchart detailing the operation of the subscriber equipment in FIG. 3 when processing a subscriber request.

### DETAIL DESCRIPTION OF THE DRAWINGS

Subscriber equipment is provided with a relatively large data storage device, such as a hard disk drive, and a relatively low powered processor. A data processor receives update messages from a filter that provides updates in accordance with a service subscription package. When the data processor determines that the information code of the update message is on the subscriber's watch list, the data processor processes the update and provides the processed update for display or further processing. When the data processor determines that the received information code is that of a selected record i.e. one that the subscriber is interested in, the data processor processes the update and stores the processed update in a cache. However, when the data processor determines that the information code of the update message is not of interest to the subscriber i.e. is not on the subscriber's watch list and is not that of a selected record, then the data processor does not process the record. Instead, the data processor indexes and stores the unprocessed record in the data storage device. Intermediate consolidated update messages and complete consolidated update messages are received and processed in a similar way.

When the subscriber selects a record which is not a selected record and is not on the watch list, the data processor uses the information code of the newly selected record and, with the assistance of the assigned indexes, locates all associated updates stored in the data storage device; processes the updates; and composes the updates to produce an updated image of the record i.e. with all fields updated. The data processor then provides the updated record for display or further processing. Subsequently, the newly selected information code is added to the watch list and the data processor then process and applies any update messages received with the information code of the newly selected record.

This advantageously allows the subscriber equipment to provide updated records for a newly selected record without the need for an additional communication link. In addition, as the data processor only processes update messages of records that are of interest to the subscriber, due to the lower volume of update message traffic, the data processor need not be a high powered processor to accomplish this task.

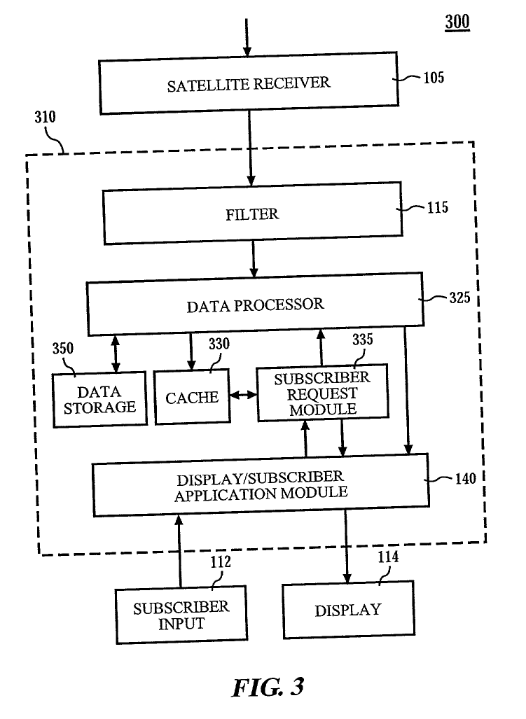

In FIG. 3 subscriber equipment 300 for receiving and processing update messages in accordance with the present invention comprises a satellite receiver 105 coupled to a computer 310, which for simplicity of description, includes a subscriber input 112, such as a keyboard and mouse, and a display 114. The computer 310, comprises a microprocessor-based system with data storage devices, such as random access memory integrated circuits, and hard disk drives, operating in accordance with one or more stored software programs. The combination of the data storage devices provides a relatively large data storage space which is used to archive or store update messages that are received but are not of interest to the subscriber. The computer provides a variety of functional modules including a filter 115, a data processor 325, a cache 330, a subscriber request module 335, a data storage module 350, and a display/subscriber application module 140.

As before, the satellite receiver 105 receives broadcasts of update messages from the information service provider (not shown) and provides the received update messages to the filter 115. The filter 115 passes only the update messages that provide updates for records in accordance with a subscriber's service subscription package. Again, this is accomplished by checking the information code of an update message, and determining that the information code complies with the information codes of records provided with the service subscription package. The filter 115 filters the update message and provides filtered data, which the data processor 325 then processes to recover the transmitted update.

Typically, both the satellite receiver 105 and the computer 310 comprise proprietary equipment that is provided by the information service provider to a subscriber upon subscription. The function of the filter 115, akin to a cable box of a cable service subscriber. The computer 320 can comprise any of a variety of readily available personal computers, having for example a Pentium® processor manufactured by Intel Corporation of the USA. The cache 330 comprises a combination of random access memory (RAM) integrated circuits (ICs) having a capacity of say 128 megabytes, and magnetic media such as a hard disk drive. The display 114 can comprise a cathode ray tube or a liquid crystal display; and the subscriber input 112 typically includes a QWERTY keyboard and a mouse. The data storage module 350 is a relatively large memory device, usually a hard disk drive and may be a shared resource with the cache 330. For example, it is anticipated that the data storage device comprising a hard disk with a capacity of 20 gigabytes (GB) would be required for storage of broadcast update message traffic of 1 megabits per second (MBPS), and that one with a storage capacity of up to 100 GB would be required for storage of broadcast traffic of 4 MBPS. It will be appreciated that a variety of data storage devices utilizing magnetic, optic or semiconductor media having the required data storage capacity can also be employed.

The function of the data processor 325 is provided by software resident in the data storage module 350 and executed by the microprocessor. The data processor 325 receives update messages and when the information code of the update message is that of a selected record i.e. one stored in the cache 330, the data processor 325 processes the update message and updates the record stored in the cache 330. When the information code of the received update message is on the subscriber's watch list, the data processor 325 processes the update message and provides the processed update directly to the display/subscriber application module 140. However, when the information code of the update message is not that of a selected record and is not on the subscriber's watch list, then the data processor does not process the record. Instead, the data processor 325 indexes the update message and stores the record in the data storage module 350. Indexing, as is known, facilitates subsequent retrieval of the update message(s).

When processing update messages, the intermediate consolidated update messages and the complete consolidated update messages, the data processor performs processes such as decryption and decompression of the received data. When applying an update, the data processor replaces information of fields of a record with the update information for those fields that are provided by the update.

The subscriber request module 335 is another functional module provided by the combination of software executed by a microprocessor. The subscriber request module 335 receives and processes subscriber requests from a subscriber that are provided via the display/subscriber application module 140, which may result from an input provided by a subscriber to the user input 112. A subscriber request comprises an information code of a requested record, and the subscriber request module 335 initially determines whether the information code is that of a selected record. When the requested information code is that of a selected record, the subscriber request module 335 retrieves the record from the cache 330 and provides the retrieved record to the display/subscriber application module 140. However, when the information code is not that of a selected record, the subscriber request module 335 provides the information code to the data processor 325. The data processor 325 searches the data storage module 350 for all update messages having the information code, using the information code and the assigned indexing. The data processor 325 then composes the located update messages to produce an updated image of the requested record, and provides the updated image of the requested record to the display/subscriber application module 140. Subsequently, the data processor 325 adds the information code of the newly requested record to the subscriber watch list. Upon receipt of all update messages having the newly requested information code, the data processor 325 then processes and provides the updates directly to the display/subscriber application module 140.

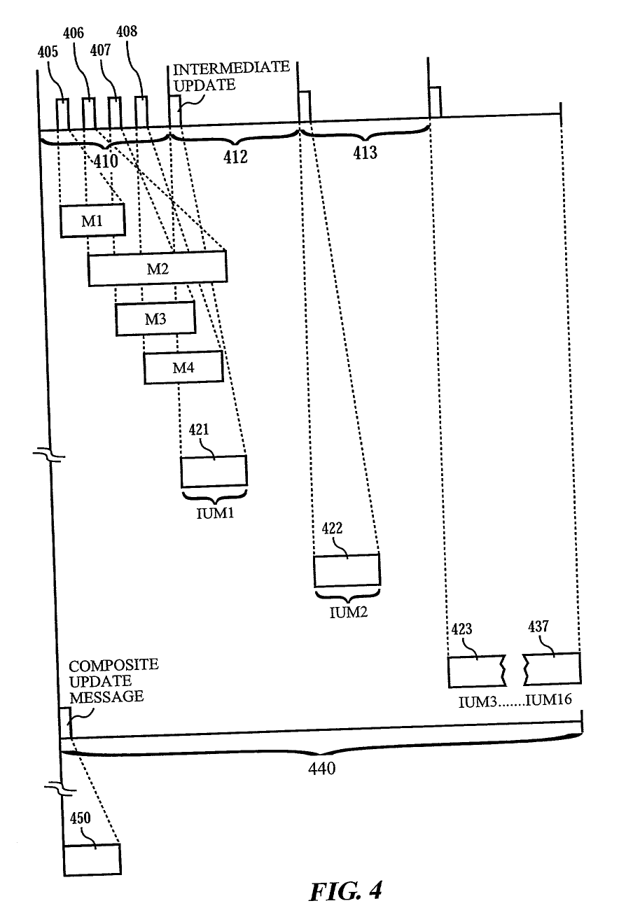

With reference to FIG. 4, for a particular record, an information service provider transmits update messages, and the update messages 405-408 are received by the subscriber equipment 300 within a first fifteen-minute period 410. The update messages 405-408 provide updates M1-M4, respectively, of the record. There are sixteen fifteen-minute periods 412,413, etc, in four hours, and although not illustrated, update messages are received in each of the other fifteen-minute periods. After the first fifteen-minute period 410, an intermediate consolidated update message 421 is broadcast providing an aggregated update IUM1 of the updates M1-M4, which were transmitted in the prior fifteen-minute period 410. Similarly, after each of the subsequent fifteen-minute periods 412,413, etc., corresponding intermediate consolidated update messages 421, 422-437, respectively, are transmitted. At the end of a four-hour period 440, a complete consolidated update message 450 is transmitted. The complete consolidated update message 450 comprises all the fields of the record, and provides what is referred to as a snapshot of the record. All the fields provide the current information of the record.

The operation of the subscriber equipment 300 is dependent on the operation of the computer 320 under the control of one or more software programs, which can be stored in the data storage module 350. The process of executing a software program stored in a computer is known to one skilled in the art, and no further details are provided herein.

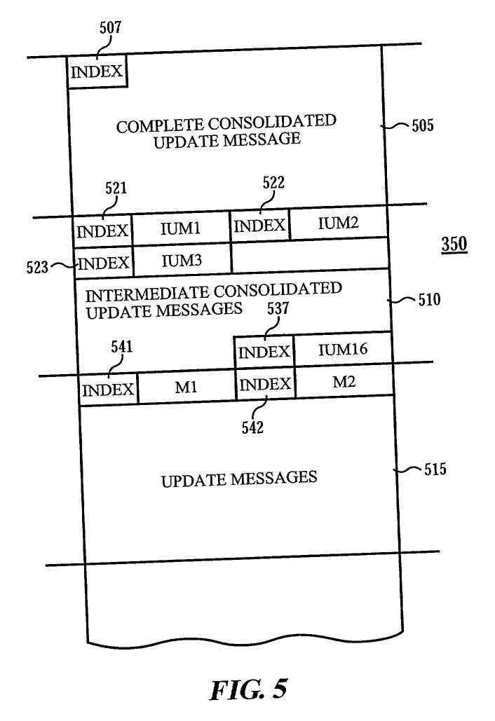

In FIG. 5 the data storage module 350 has three virtual storage spaces, as managed by software, such as the operating system of the computer 310. A first storage space 505 stores a complete consolidated update message 450; a second storage space 510 stores sixteen intermediate consolidated update messages IUM1-IUM16, each comprising update messages received in subsequent fifteen-minute periods after the complete consolidated update message 450; and a third storage space 515 stores update messages M1-M4, etc. as the update messages are received over a fifteen-minute period as directed by the data processor 325.

The complete consolidated update message 450 is stored with an index 507 assigned by the data processor 325. Similarly, each of the intermediate consolidated update messages IUM1-IUM16 is stored with an index 521-53 and, each update message M1-M4, etc. is assigned an index 541, 542, etc. assigned by the data processor 325. The index assignments allows the data processor 325 to locate and retrieve the update messages of a particular record in the data storage module 350 when the particular record is requested by the subscriber, and the particular record is not currently on the subscriber's watch list and is not a selected record. Therefore, in total, the minimum storage capacity of the data storage module 350 has to be sufficient for storing eight hours and fifteen minutes of update messages. For a variety of practical considerations the data storage capacity of the data storage module 350 that is employed is larger than the minimum storage capacity.

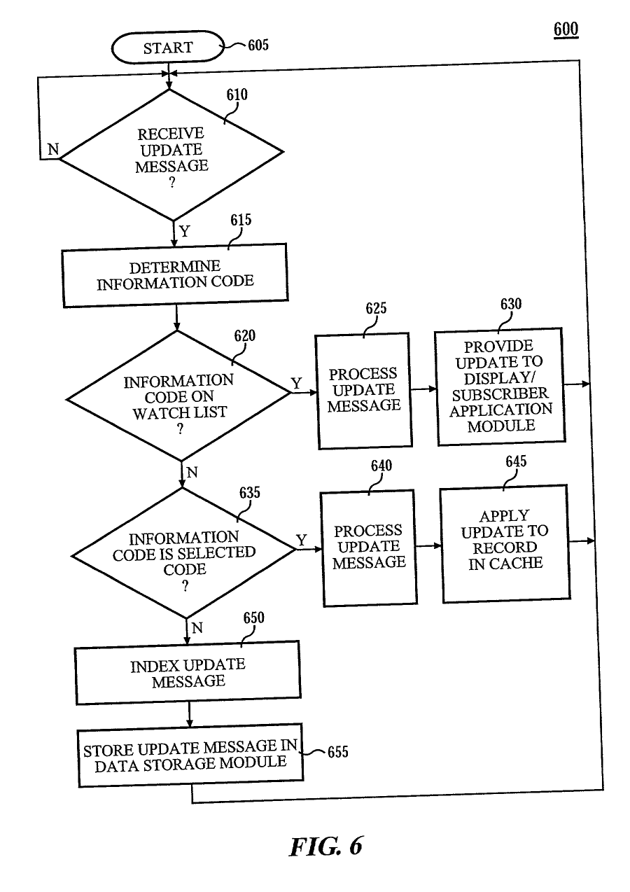

With reference to FIG. 6 the operation 600 of the subscriber equipment 300 for processing update messages starts 605 with the data processor 325 determining 610 whether an update message has been received. When an update message is received the information code is determined 615, however, when an update message has not been received, the data processor 325 continues to monitor 610 receipt of an update message.

A determination 620 is then made when an update message is received, as to whether the information code is on the subscriber's watch list and if not, a further determination 635 is made as to whether the information code is a selected code. When the information code is on the subscriber's watch list, the update message is processed 625 by the data processor 325 and provided 630 directly to the display/subscriber application module 140, after which the data processor 325 returns to monitoring 610 receipt of update messages.

Alternatively, when the information code is a selected code, the update message is processed 640 by the data processor 325 and the update is applied 645 to the respective record stored in the cache 330. The data processor 325 then returns to monitoring 610 receipt of update messages.

When the information code of the update message is neither on the subscriber's watch list nor a selected code, then the data processor 325 indexes 650 the update message as received, and stores 655 the unprocessed update message in the third storage space 515 of the data storage module 350. Again, the data processor 325 then returns to monitoring 610 receipt of subsequent update messages.

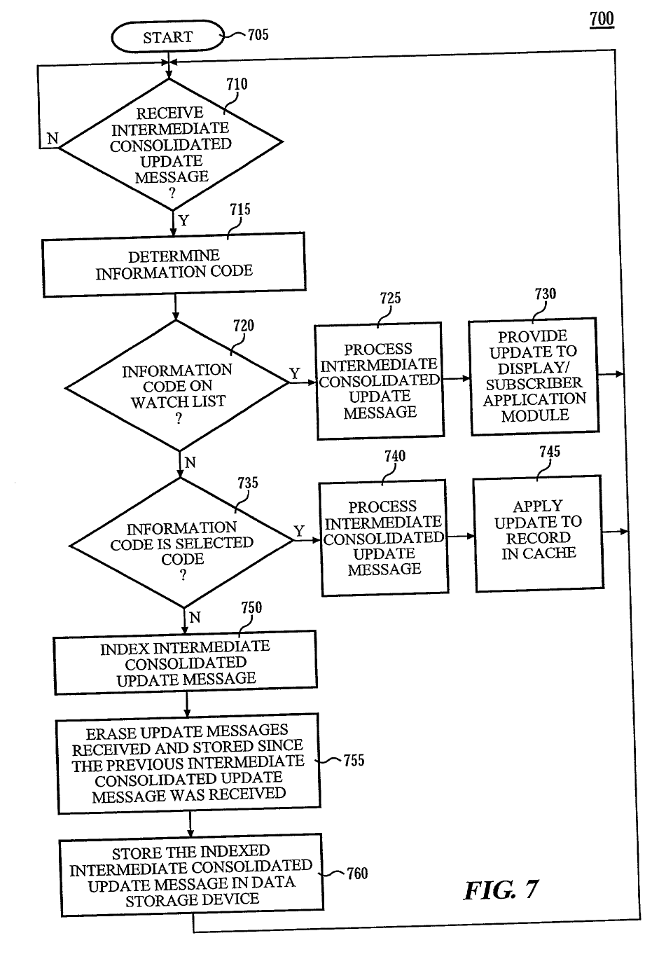

With reference to FIG. 7 the operation 700 of the subscriber equipment 300 for processing intermediate consolidated update messages starts 705 with the data processor 325 determining 710 whether an intermediate consolidated update message has been received. When an intermediate consolidated update message is received the information code is determined 715, however, when an intermediate consolidated update message has not been received, the data processor 325 continues to monitor 710 receipt of an intermediate consolidated update message.

A determination 720 is then made when an intermediate consolidated update message is received as to whether the information code is on the subscriber's watch list and if not, a further determination 735 is made as to whether the information code is a selected code. When the information code is on the subscriber's watch list, the intermediate consolidated update message is processed 725 by the data processor 325 and provided 730 directly to the display/subscriber application module 140, after which the data processor 325 returns to monitoring 710 receipt of subsequent intermediate consolidated update messages.

Alternatively, when the information code is a selected code, the intermediate consolidated update message is processed 740 by the data processor 325 and the intermediate consolidated update is applied 745 to the respective record stored in the cache 330. The data processor 325 then returns to monitoring 710 receipt of subsequent intermediate consolidated update messages.

When the information code of the intermediate consolidated update message is neither on the subscriber's watch list nor a selected code, then the data processor 325 indexes 750 the intermediate consolidated update message, as received. The data processor 325 then erases 755 update messages received and stored in the third storage space 515 of the data storage module 350 since the previous intermediate consolidated update message was received. The data processor 325 then stores 760 the indexed intermediate consolidated update message in the second storage space 510 of the data storage module 350. Again, the data processor 325 then returns to monitoring 710 receipt of subsequent intermediate consolidated update messages.

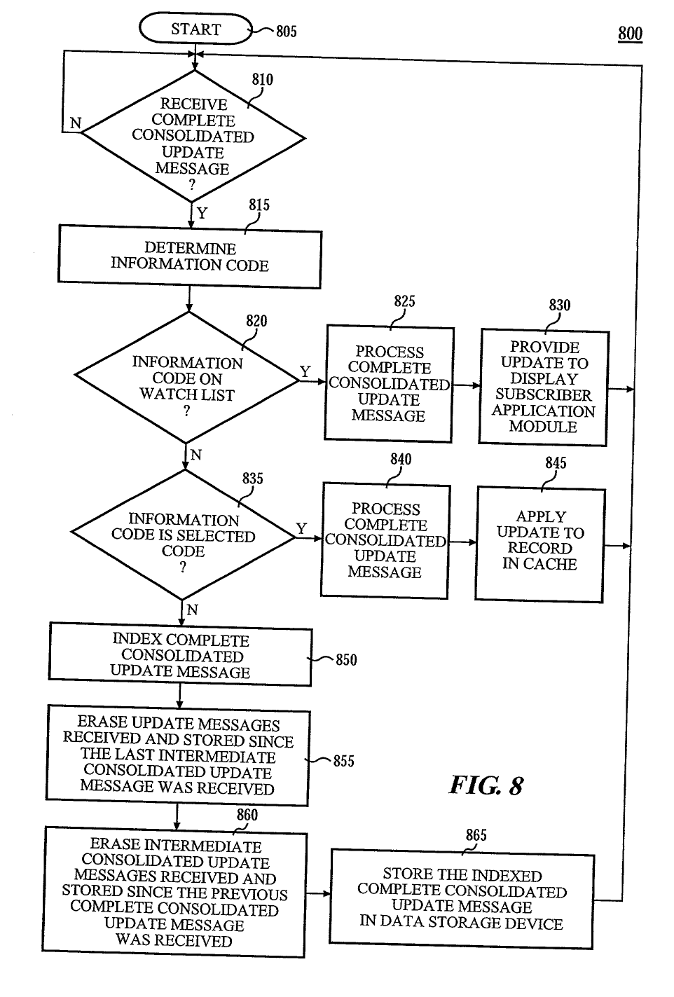

With reference to FIG. 8 the operation 800 of the subscriber equipment 300 for processing complete consolidated update messages starts 805 with the data processor 325 determining 810 whether a complete consolidated update message has been received. When a complete consolidated update message is received the information code is determined 815. However, when a complete consolidated update message has not been received, the data processor 325 continues to monitor 810 receipt of subsequent complete consolidated update messages.

A determination 820 is then made as to whether the information code is on the subscriber's watch list and if not, a further determination 835 is made as to whether the information code is a selected code. When the information code is on the subscriber's watch list, the complete consolidated update message is processed 825 by the data processor 325 and provided 830 directly to the display/subscriber application module 140, after which the data processor 325 returns to monitoring 810 receipt of subsequent complete consolidated update messages.

Alternatively, when the information code is a selected code, the complete consolidated update message is processed 840 by the data processor 325 and the complete consolidated update is applied 845 to the respective record stored in the cache 330. The data processor 325 then returns to monitoring 810 receipt of subsequent complete consolidated update messages.

When the information code of the complete consolidated update message is neither on the subscriber's watch list nor a selected code, then the data processor 325 indexes 850 the complete consolidated update message, as received, with an index 507. The data processor 325 then erases 855 update messages received and stored in the third storage space 515 of the data storage module 350 since the last intermediate consolidated update message was received. The data processor 325 also erases 860 intermediate consolidated update messages stored in the second storage space 510 of the data storage module 350 since the previous complete consolidated update message was received.

The data processor 325 then stores 865 the indexed complete consolidated update message in the first storage space 505 of the data storage module 350. Again, the data processor 325 then returns to monitoring 710 receipt of subsequent intermediate consolidated update messages.

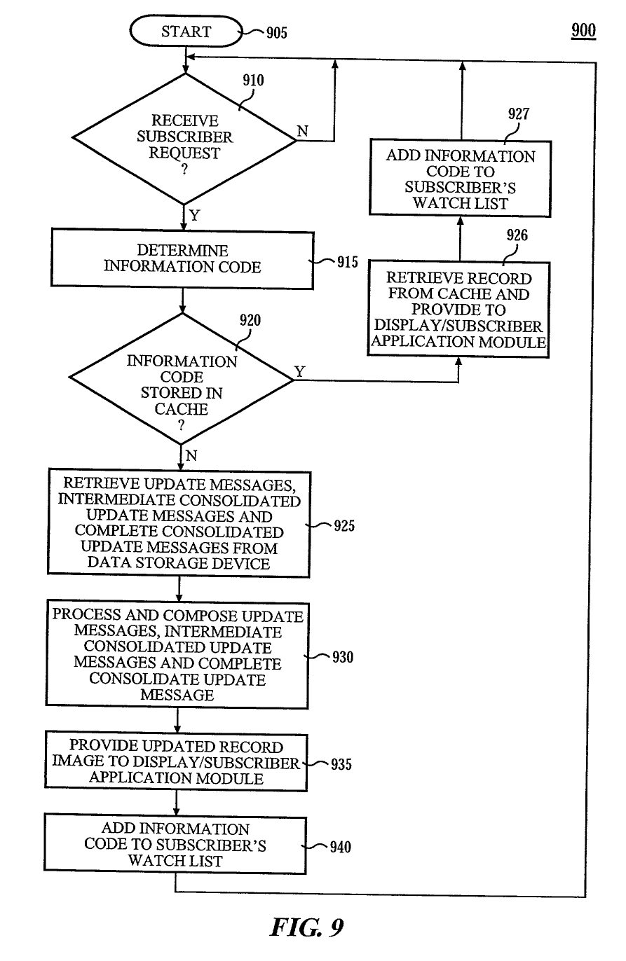

Hence, the subscriber equipment, as described, advantageously does not require an additional back link to the information service provider, as all information that is received is stored either in the cache or the data storage module, and can be retrieved and presented or further processed, as required by the subscriber. In addition, as the processor does not process all the update messages that are received, the processor need not be a more powerful processor. The present invention thus advantageously uses a cheaper hard disk instead of the more expensive powerful processor With reference to FIG. 9, a process 900 for processing subscriber requests starts 905 with the subscriber request module 335 monitoring 910 receipt of a subscriber request. When a subscriber request is received from the subscriber input 112 via the display/subscriber application module 140, a determination 915 of the information code provided by the subscriber request is made. A further determination 920 is then made as to whether the information code is a selected code i.e. if its stored in the cache 330. When the information code is stored in the cache 330, the respective record is retrieved 926 from the cache 330 and provided to the display/subscriber application module 140, and the requested information code added 927 to the subscriber's watch list. The subscriber request module 335 then returns to monitoring 910 receipt of subsequent subscriber requests.

When the information code is not available in the cache 330, the subscriber request module 335 provides the request to the data processor 325. The data processor 325 uses the information code and previously assigned indexes to retrieve 925 all update message(s), intermediate consolidate update message(s) and the complete consolidated update message from the data third, second and first storage spaces 515, 510 and 505 of the data storage module 350, respectively. The data processor 325 then processes and composes 930 the update message(s), intermediate consolidate update message(s) and the complete consolidated update message, and provides 935 an updated image of the requested record to the display/subscriber application module 140. The requested information code is then added 940 to the subscriber's watch list and the process 900 returns to monitoring 910 receipt of subsequent subscriber requests.

The present invention, as described, provides subscriber equipment that does not require an additional communication link back to the information service provider, and does not need a high powered processor.

This is accomplished by only processing update messages for records that a subscriber is interested in and storing all other update messages without processing them. When the subscriber selects a new record which he was previously not interested in, the subscriber equipment retrieves the respective update messages of the requested record from storage, composes the associated update messages to produce an update image of the requested record, and presents the requested record to the subscriber for display or further processing. In addition, the requested record is then added to the subscriber's watch list so that subsequent updates for the record are applied when received.

The present invention therefore provides subscriber equipment for broadcast information and a method therefor which overcomes, or substantially reduces, the abovementioned problems of the prior art.

It will be appreciated that although only one particular embodiment of the invention has been described in detail, various modifications and improvements can be made by a person skilled in the art without departing from the scope of the present invention.

1. An apparatus for continuously receiving update messages for a plurality of records, wherein each of the plurality of records has an identifier (ID), and wherein each update message comprises an update and one of the IDs, the apparatus comprising:
an input for receiving at least some of the update messages;
a processor coupled to the input, the processor for processing each update message when the ID of the update message is one of a first plurality of IDs, and for providing a processed update and the one of the first plurality of IDs to a first output, and the processor for providing the update message and the ID of the update message to a second output, without first processing the update message, when the ID of the received update message is not one of the first plurality of IDs; and
a first memory coupled to the second output for storing the update message and the ID of the update message.

2. An apparatus in accordance with claim 1 wherein the processor further comprises a third output, the processor for processing the update message when the ID of the update message is one of a second plurality of IDs, and the processor for providing a processed update and the one of the second plurality of IDs to a third output; and wherein the apparatus further comprises a second memory coupled to the third output for storing the processed update and the one of the second plurality of IDs

3. An apparatus in accordance with claim 2 further comprising a user application module coupled to the first output for receiving the processed update and the one of the first plurality of IDs, and for processing the update message in accordance with user specific requirements.

4. An apparatus in accordance with claim 3 wherein the application module comprises a display module for preparing the update for presentation on a display.

5. An apparatus in accordance with claim 4 further comprising a user input device coupled to the application module, the user input device for providing inputs from a user to the application module.

6. An apparatus in accordance with claim 3 further comprising a request module coupled to receive a user request that provides at least one ID, the request module coupled to the second memory for determining whether a record having the at least one ID is stored in the second memory, and when the record having the at least one ID is stored in the second memory, the request module retrieving the record having the at least one ID from the second memory, and the request module coupled to provide the record having the at least one ID to the application module.

7. An apparatus in accordance with claim 6 wherein the request module is further coupled to the processor for providing the at least one ID to the processor when a record having the at least one ID is not stored in the second memory, the processor coupled to the first memory for retrieving update messages having the at least one ID therefrom, for processing the retrieved update messages to produce an updated record, and the processor for providing the updated record to the application module.

8. An apparatus in accordance with claim 7 wherein the first memory comprises a magnetic data storage device.

9. An apparatus in accordance with claim 7 wherein the second memory comprises a semiconductor data storage device.

10. An apparatus in accordance with claim 7 wherein the first memory comprises a magnetic data storage device, and wherein the second memory comprises a semiconductor data storage device.

11. An apparatus in accordance with claim 7 further comprising a filter coupled to receive broadcast update messages for the plurality of records, and the filter coupled to the input for providing the at least some of the update messages.

12. An apparatus in accordance with claim 1 further comprising a receiver for receiving a broadcast signal, and the receiver coupled to the filter to provide the broadcast update messages.

13. A method for processing update messages for a plurality of records, wherein each of the plurality of records has an identifier (ID), and wherein each update message comprises an update and one of the IDs, the method comprising the steps of:
receiving at least some of the update messages;
when the ID of a received update message is one of a first plurality of IDs, processing the update message to produce an update and providing the update and the ID of the received update message to a first output; and
when the ID of the received update message is not of the first plurality IDs, storing the update message and the ID of the received update message in a first memory, without first processing the update message.

14. A method in accordance with claim 13 further comprising the step of processing the update message to produce an update, and storing the update and the ID of the received update message in a second memory when the ID of the received update message is one of a second plurality of IDs.

15. A method in accordance with claim 14 further comprising the steps of:
receiving the update and the ID of the received update message from the first output; and
processing the update in accordance with user specific requirements.

16. A method in accordance with claim 15 wherein the processing step further comprises the step of preparing the update for presentation on a display.

17. A method in accordance with claim 15 further comprising the step of receiving the user specific requirements prior to the step of processing

18. A method in accordance with claim 15 further comprising the steps of:
receiving a user request that provides at least one ID;
determining whether a record having the at least one ID is stored in the second memory;
when the record having the at least one ID is stored in the second memory, retrieving the record having the at least one ID from the second memory; and
processing the record having the at least one ID in accordance with user specific requirements.

19. A method in accordance with claim 18 further comprising the steps of:
retrieving update messages having the at least one ID from the first memory when the record having the at least one ID is not stored in the second memory;
processing the retrieved update messages to produce an update record; and
processing the update record in accordance with user specific requirements.

20. A method in accordance with claim 13 further comprising the steps of:
receiving broadcast update messages for the plurality of records; and
providing the some of the update messages.
